(19) United States
(12) Patent Application Publication
(10) Pub. No.: US 2021/0097715 A1
(43) Pub. Date: Apr. 1, 2021

(54) IMAGE GENERATION METHOD AND DEVICE, ELECTRONIC DEVICE AND STORAGE MEDIUM

(71) Applicant: BEIJING SENSETIME TECHNOLOGY DEVELOPMENT CO., LTD., Beijing (CN)

(72) Inventors: Yining LI, Bejing (CN); Chen Huang, Beijing (CN); Chen Change Loy, Beijing (CN)

(21) Appl. No.: 17/117,749

(22) Filed: Dec. 10, 2020

Related U.S. Application Data
(63) Continuation of application No. PCT/CN2020/071966, filed on Jan. 14, 2020.

(30) Foreign Application Priority Data
Mar. 22, 2019 (CN) 201910222054.5

(51) Int. Cl. G06T 7/73

(52) U.S. Cl. CPC G06T 7/73; G06T 2207/20081; G06T 2207/20084

(57) ABSTRACT

An image generation method and device, and a storage medium are provided. The method includes that: an image to be processed, first pose information corresponding to an initial pose of a first object in the image to be processed and second pose information corresponding to a target pose to be generated are acquired; pose switching information is obtained according to the first pose information and second pose information, the pose switching information including an optical flow map between the initial pose and the target pose and/or a visibility map of the target pose; and a first image is generated according to the image to be processed, the second pose information and the pose switching information.

### CROSS-REFERENCE TO RELATED APPLICATIONS

The present application is a continuation of International Patent Application No. PCT/CN2020/071966, filed on Jan. 14, 2020, which claims priority to Chinese Patent Application No. 201910222054.5, filed on Mar. 22, 2019. The content of International Patent Application No. PCT/CN2020/071966 and Chinese Patent Application No. 201910222054.5 is hereby incorporated by reference in their entireties.

### BACKGROUND

In related art, an optical flow method and the like are usually adopted to change a pose of an object in an image to generate an image including the object of which the pose is changed.

### SUMMARY

The disclosure discloses an image generation method and device, and a storage medium.

According to an aspect of the disclosure, an image generation method is provided, which may include the following operations. An image to be processed, first pose information corresponding to an initial pose of a first object in the image to be processed and second pose information corresponding to a target pose to be generated are acquired. Pose switching information is obtained according to the first pose information and the second pose information, the pose switching information including an optical flow map between the initial pose and the target pose and/or a visibility map of the target pose. A first image is generated according to the image to be processed, the second pose information and the pose switching information, where a pose of the first object in the first image is the target pose.

According to another aspect of the disclosure, an image generation device is provided, which may include a processor; and a memory, configured to store instructions executable by the processor, where the processor is configured to execute the above image generation method.

According to an aspect of the disclosure, a computer-readable storage medium is provided, having stored thereon computer program instructions that, when being executed by a processor, enable the processor to implement the above image generation method.

It is to be understood that the above general description and the following detailed description are only exemplary and explanatory and not intended to limit the disclosure.

According to the following detailed descriptions made to exemplary embodiments with reference to the drawings, other features and aspects of the disclosure may become clear.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 is a flowchart of an image generation method according to an embodiment of the disclosure.

FIG. 2 is a schematic diagram of first pose information according to an embodiment of the disclosure.

FIG. 3 is a flowchart of an image generation method according to an embodiment of the disclosure.

FIG. 4 is a schematic diagram of training of an optical flow network according to an embodiment of the disclosure.

FIG. 5 is a schematic diagram of a feature transformation subnetwork according to an embodiment of the disclosure.

FIG. 6 is a flowchart of an image generation method according to an embodiment of the disclosure.

FIG. 7 is a flowchart of an image generation method according to an embodiment of the disclosure.

FIG. 8 is a schematic diagram of training of an image generation network according to an embodiment of the disclosure.

FIG. 9 is a schematic diagram of application of an image generation method according to an embodiment of the disclosure.

FIG. 10 is a block diagram of an image generation device according to an embodiment of the disclosure.

FIG. 11 is a block diagram of an image generation device according to an embodiment of the disclosure.

FIG. 12 is a block diagram of an image generation device according to an embodiment of the disclosure.

FIG. 13 is a block diagram of an image generation device according to an embodiment of the disclosure.

FIG. 14 is a block diagram of an electronic device according to an embodiment of the disclosure.

FIG. 15 is a block diagram of an electronic device according to an embodiment of the disclosure.

### DETAILED DESCRIPTION

Each exemplary embodiment, feature and aspect of the disclosure will be described below with reference to the drawings in detail. The same reference signs in the drawings represent components with the same or similar functions. Although each aspect of the embodiments is shown in the drawings, the drawings are not required to be drawn to scale, unless otherwise specified.

Herein, the specific term “exemplary” refers to “as an example, embodiment or description”. Herein, any “exemplarily” described embodiment must not be interpreted as being preferred over or better than other embodiments.

In the disclosure, the term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, for describing the disclosure better, many specific details are presented in the following specific implementation modes. It is understood by those skilled in the art that the disclosure may still be implemented even without some specific details. In some examples, methods, means, components and circuits well known by those skilled in the art are not described in detail, so as to highlight the subject matter of the disclosure.

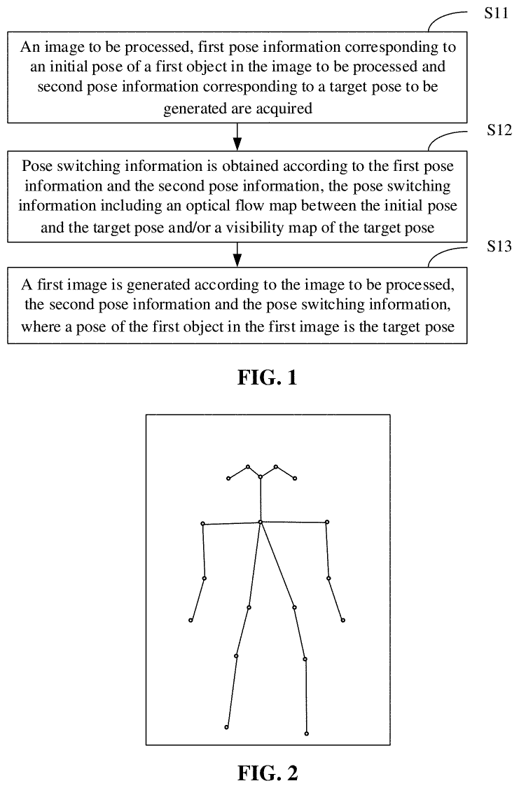

FIG. 1 is a flowchart of an image generation method according to an embodiment of the disclosure. As shown in FIG. 1, the method includes the following steps.

In S11, an image to be processed, first pose information corresponding to an initial pose of a first object in the image to be processed and second pose information corresponding to a target pose to be generated are acquired.

In S12, pose switching information is obtained according to the first pose information and the second pose information. The pose switching information includes an optical flow map between the initial pose and the target pose and/or a visibility map of the target pose.

In S13, a first image is generated according to the image to be processed, the second pose information and the pose switching information. A pose of the first object in the first image is the target pose.

According to the image generation method of the embodiment of the disclosure, the visibility map is obtained according to the first pose information and the second pose information, so that a visibility of various parts of the first object is obtained. A visible part of the first object in the target pose is displayed in the generated first image, so that image distortions may be improved, and artifacts may be reduced.

In a possible implementation mode, the first pose information is configured to represent a pose of the first object in the image to be processed, i.e., the initial pose.

In a possible implementation mode, the operation that the first pose information corresponding to the initial pose of the first object in the image to be processed may include that: pose feature extraction is performed on the image to be processed to obtain the first pose information corresponding to the initial pose of the first object in the image to be processed.

In a possible implementation mode, pose feature extraction may be performed on the image to be processed through a method such as a convolutional neural network. For example, if the first object is a person, a body key point of the first object may be extracted in the image to be processed, the initial pose of the first object may be represented through the body key point, and position information of the body key point may be determined as the first pose information. A method for extracting the first pose information is not limited in the disclosure.

In an example, multiple key points, for example, 18 key points, of the first object may be extracted in the image to be processed through the convolutional neural network, and positions of the 18 key points may be determined as the first pose information. The first pose information may be represented as a feature map including the key points.

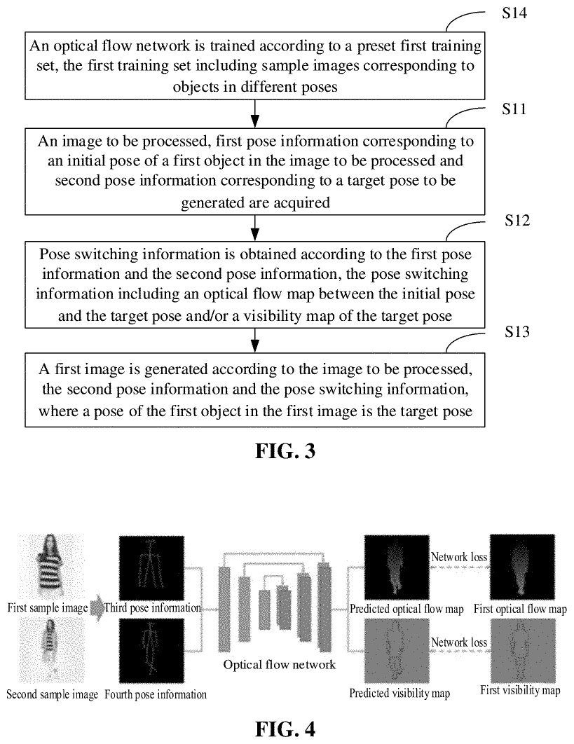

FIG. 2 is a schematic diagram of first pose information according to an embodiment of the disclosure. As shown in FIG. 2, a position coordinate of the key point in the feature map (i.e., the first pose information) may be the same as a position coordinate in the image to be processed.

In a possible implementation mode, the second pose information is configured to represent the target pose to be generated and may be represented as a feature map formed by key points. The second pose information may represent any pose. For example, the positions of the key points in the feature map corresponding to the first pose information may be adjusted to obtain the second pose information, or key point extraction may be performed on an image of any object in any pose to obtain the second pose information. The second pose information may also be represented as a feature map including key points.

In a possible implementation, in S12, the pose switching information may be obtained according to the first pose information and second pose information of the first object. The pose switching information includes the optical flow map between the initial pose and the target pose and/or the visibility map of the target pose. The optical flow map is an image formed by displacement vectors that each pixel of the first object is adjusted from the initial pose to the target pose. The visibility map represents pixel points, which can be presented in the image, of the first object in the target pose. For example, if the initial pose is standing with the feet facing forward and the target pose is standing with the feet facing the left/right, some parts of the first object in the target pose may not be presented (for example, may be occluded) in the image, namely part of pixels are invisible and cannot be presented in the image.

In a possible implementation mode, if the second pose information is extracted from an image of any object in any pose, three-dimensional modeling may be performed on the image to be processed and the image of any object in any pose to obtain two three-dimensional models respectively. A surface of the three-dimensional model is formed by multiple vertexes, for example, formed by 6,890 vertexes. The vertex corresponding to a certain pixel of the image to be processed may be determined in the respective three-dimensional model, a position of the vertex in the three-dimensional model corresponding to the image including any object in any pose may also be determined, and a pixel corresponding to the vertex is determined in the image of any object in any pose, where the pixel is a pixel corresponding to the certain pixel. Furthermore, an optical flow between the two pixels may be determined according to the positions of the certain pixel and the corresponding pixel. In such a manner, an optical flow of various pixels of the first object is determined, so as to obtain the optical flow map.

In a possible implementation mode, visibility of vertexes in the three-dimensional model corresponding to the image of any object in any pose may be determined. For example, whether a certain vertex is occluded or not in the target pose may be determined, thereby determining the visibility of the pixel corresponding to the vertex in the image of any object in any pose. In the example, the visibilities of pixels may be represented with discrete numbers. For example, the number 1 represents that the pixel is visible in the target pose, the number 2 represents that the pixel is invisible in the target pose, and the number 0 represents that the pixel is a pixel in a background region, namely not a pixel corresponding to the first object. Furthermore, the visibility of pixels corresponding to the first object may be determined in such a manner to obtain a visibility map. Representation for the visibility is not limited in the disclosure.

In a possible implementation mode, the method is implemented through a neural network, the neural network includes an optical flow network configured to obtain the pose switching information. The first pose information and the second pose information may be input to the optical flow network to generate the pose switching information.

In a possible implementation mode, before the pose switching information is obtained by use of the optical flow network, the optical flow network may be trained.

FIG. 3 is a flowchart of an image generation method according to an embodiment of the disclosure. As shown in FIG. 3, the method further includes the following step S14.

In S14, the optical flow network is trained according to a preset first training set, the first training set including sample images corresponding to objects in different poses.

In a possible implementation mode, S14 may include the following operations. Three-dimensional modeling is performed on a first sample image and second sample image in the first training set to obtain a first three-dimensional model and a second three-dimensional model respectively. A first optical flow map between the first sample image and the second sample image and a first visibility map of the second sample image are obtained according to the first three-dimensional model and the second three-dimensional model. Pose feature extraction is performed on the first sample image and the second sample image to obtain third pose information of the object in the first sample image and fourth pose information of the object in the second sample image respectively. The third pose information and the fourth pose information are input to the optical flow network to obtain a predicted optical flow map and a predicted visibility map. Network loss of the optical flow network is determined according to the first optical flow map, the predicted optical flow map, the first visibility map and the predicted visibility map. The optical flow network is trained according to the network loss of the optical flow network.

FIG. 4 is a schematic diagram of training of an optical flow network according to an embodiment of the disclosure. As shown in FIG. 4, the first training set may include sample images corresponding to objects in different poses. Three-dimensional modeling may be performed on the first sample image and the second sample image to obtain the first three-dimensional model and the second three-dimensional model respectively. By three-dimensional modeling of the first sample image and the second sample image, the optical flow map between the first sample image and the second sample image may be accurately obtained and moreover, may determine a vertex that is presented (i.e., a visible vertex) and a vertex that is occluded (i.e., an invisible vertex) in the second sample image may be determined according to position relationship between vertexes in the three-dimensional models, so as to determine the visibility map of the second sample image.

In a possible implementation mode, a vertex of a pixel in the first sample image may be determined in the first three-dimensional model, a position of the vertex may also be determined in the second three-dimensional model, and a pixel corresponding to the vertex in the second sample image is determined according to the position, where the pixel corresponding to the vertex in the second sample image is a pixel corresponding to a certain pixel in the first sample image. Furthermore, an optical flow between the two pixels may be determined according to the positions of the certain pixel and its corresponding pixel. In such a manner, optical flows of various pixels may be determined to obtain the first optical flow map, where the first optical image is an accurate optical flow map between the first sample image and the second sample image.

In a possible implementation mode, whether the pixels corresponding to vertexes of the second three-dimensional model are displayed in the second sample image or not may be determined according to the position relationship between vertexes of the first three-dimensional model and the vertexes of the second three-dimensional model, and thus to determine a first visibility map of the second sample image. In some examples, visibility of the pixels may be represented with discrete numbers. For example, the number 1 represents that the pixel is visible in the second sample image, the number 2 represents that the pixel is invisible in the second sample image, and the number 0 represents that the pixel is a pixel in a background region, namely not a pixel in a region where the object in the second sample image is located. Furthermore, in such a manner, the visibility of the pixels may be determined to obtain a first visibility map of the second sample image, where the first visibility map is an accurate visibility map of the second sample image. the representation for the visibility is not limited in the disclosure.

In a possible implementation mode, pose feature extraction may be performed on the first sample image and the second sample image respectively. In some examples, a number of 18 key points of an object in the first sample image and 18 key points of an object in the second sample image may be extracted to obtain the third pose information and the fourth pose information respectively.

In a possible implementation mode, the third pose information and the fourth pose information may be input to the optical flow network to obtain the predicted optical flow map and the predicted visibility map. The predicted optical flow map and the predicted visibility map are output results of the optical flow network, which may have errors.

In a possible implementation mode, the first optical flow map is an accurate optical flow map between the first sample image and the second sample image, and the first visibility map is an accurate visibility map of the second sample image. The predicted optical flow map is an optical flow map generated by the optical flow network, and there may be a difference between the predicted optical flow map and the first optical flow map. Similarly, there may be a difference between the predicted visibility map and the first visibility map. The network loss of the optical flow network may be determined according to the difference between the first optical flow map and the predicted optical flow map and the difference between the first visibility map and the predicted visibility map. In some examples, loss of the predicted optical flow map may be determined according to the difference between the first optical flow map and the predicted optical flow map, cross entropy loss of the predicted visibility map may be determined according to the difference between the first visibility map and the predicted visibility map, and the network loss of the optical flow network may be obtained by performing weighted summation on the loss of the predicted optical flow map and the cross entropy loss of the predicted visibility map.

In a possible implementation mode, a network parameter of the optical flow network may be adjusted in a manner of minimizing the network loss. For example, the network parameter of the optical flow network may be adjusted by using a gradient descent method. After a training condition is met, the trained optical flow network is obtained. For example, the training condition is met when the number of times of training reaches a predetermined number of times, namely when the network parameter of the optical flow network is adjusted for the predetermined number of times, the trained optical flow network is obtained. Or, the training condition is met when the network loss is less than or equal to a preset threshold or converges to a certain interval, and the optical flow network is obtained. The trained optical flow network may be configured to obtain the pose switching information.

In such a manner, the optical flow network may be trained to generate an optical flow map and a visibility map according to any pose information, which provides basis for generating the first image of the first object in any pose. The optical flow network trained through the three-dimensional models is of higher accuracy, and generating the visibility map and the optical flow map by use of the trained optical flow network saves processing resources.

In a possible implementation mode, in S13, the first image where the pose of the first object is the target pose is generated according to the image to be processed, the second pose information and the pose switching information. The operation S13 may include that: an appearance feature map of the first object is obtained according to the image to be processed and the pose switching information; and the first image is generated according to the appearance feature map and the second pose information.

In a possible implementation mode, the operation that the appearance feature map of the first object is obtained according to the image to be processed and the pose switching information may include that: appearance feature coding processing is performed on the image to be processed to obtain a first feature map of the image to be processed; and feature transformation processing is performed on the first feature map according to the pose switching information to obtain the appearance feature map.

In a possible implementation mode, the step of obtaining the appearance feature map may be implemented through the neural network, where the neural network further includes an image generation network configured for image generation. The image generation network may include an appearance feature coding subnetwork which is capable of performing appearance feature coding processing on the image to be processed to obtain the first feature map of the image to be processed. The appearance feature coding subnetwork may be a neural network such as a convolutional neural network. The appearance feature coding subnetwork may include convolutional layers of multiple levels and may obtain multiple first feature maps with different resolutions (for example, a feature pyramid formed by multiple first feature maps with different resolutions). A type of the appearance feature coding subnetwork is not limited in the disclosure.

In a possible implementation mode, the image generation network may include a feature transformation subnetwork, and the feature transformation subnetwork may perform feature transformation processing on the first feature map according to the pose switching information to obtain the appearance feature map. The feature transformation subnetwork may be a neural network such as a convolutional neural network. A type of the convolutional neural network is not limited in the disclosure.

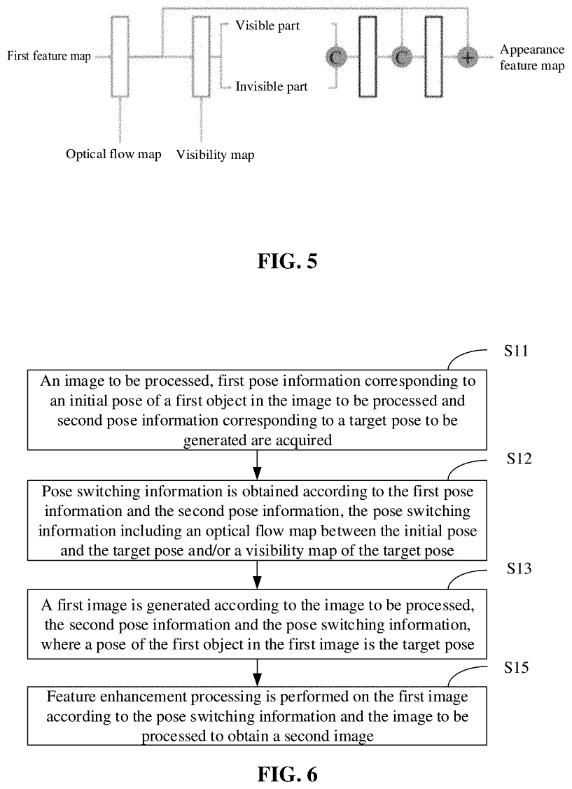

FIG. 5 is a schematic diagram of a feature transformation subnetwork according to an embodiment of the disclosure. The feature transformation subnetwork may perform shifting processing on each pixel in the first feature map according to the optical flow map and determine a visible part (i.e., multiple pixels presented in the image) and invisible part (i.e., multiple pixels not presented in the image) subjected to shifting processing according to the visibility map, and then perform processing such as convolution processing to obtain the appearance feature map. A structure of the feature transformation subnetwork is not limited in the disclosure.

In such a manner, shifting processing may be performed on the first feature map according to the optical flow map, and the visible part and invisible part may be determined according to the visibility map, so that the image distortions are improved, and the artifacts are reduced.

In a possible implementation mode, the operation that the first image is generated according to the appearance feature map and the second pose information may include that: pose feature coding processing is performed on the second pose information to obtain a pose feature map of the first object; and decoding processing is performed on the pose feature map and the appearance feature map to generate the first image.

In a possible implementation mode, the step of generating the first image may be implemented through an image generation network. The image generation network may include a pose feature coding subnetwork, which is capable of performing pose feature coding processing on the second pose information to obtain the pose feature map of the first object. The pose feature coding subnetwork may be a neural network such as a convolutional neural network. The pose feature coding subnetwork may include convolutional layers of multiple levels and may obtain multiple pose feature maps with different resolutions (for example, a feature pyramid formed by multiple pose feature maps with different resolutions). A type of the pose feature coding subnetwork is not limited in the disclosure.

In a possible implementation mode, the image generation network may include a decoding subnetwork, and the decoding subnetwork may perform decoding processing on the pose feature map and the appearance feature map to obtain the first image. In the first image, the pose of the first object is the target pose corresponding to the second pose information. The decoding subnetwork may be a neural network such as a convolutional neural network. A type of the decoding network is not limited in the disclosure.

In such a manner, the pose feature map obtained by performing pose feature coding processing on the second pose information and the appearance feature map where the visible part is distinguished from the invisible part may be decoded to obtain the first image, so that the pose of the first object in the first image may be the target pose, and thus the image distortions can be improved and the artifacts are reduced.

In a possible implementation mode, the pose of the first object in the first image is the target pose, and a high-frequency detail (for example, a wrinkle and a texture) of the first image may further be enhanced.

FIG. 6 is a flowchart of an image generation method according to an embodiment of the disclosure. As shown in FIG. 6, the method further includes the following step S15.

In S15, feature enhancement processing is performed on the first image according to the pose switching information and the image to be processed to obtain a second image.

In a possible implementation mode, the operation S15 may include that: pixel transformation processing is performed on the image to be processed according to the optical flow map to obtain a third image; a weight coefficient map is obtained according to the third image, the first image and the pose switching information; and weighted averaging processing is performed on the third image and the first image according to the weight coefficient map to obtain the second image.

In a possible implementation mode, pixel transformation processing may be performed on the image to be processed according to optical flow information of pixels in the optical flow map, namely shifting processing is performed on the pixels of the image to be processed according to the corresponding optical flow information, to obtain the third image.

In a possible implementation mode, the weight coefficient map may be obtained through an image generation network. The image generation network may include a feature enhancement subnetwork, and the feature enhancement subnetwork may process the third image, the first image and the pose switching information to obtain the weight coefficient map. For example, a weight of each pixel in the third image and the first image may be determined according to the pose switching information respectively to obtain the weight coefficient map. A value of each pixel in the weight coefficient map is the weight of the corresponding pixel in the third image and the first image. For example, if a value of a pixel of which a coordinate is (100, 100) in the weight coefficient map is 0.3, then a weight of the pixel of which the coordinate is (100, 100) in the third image is 0.3, and a weight of the pixel of which the coordinate is (100, 100) is 0.7.

In a possible implementation mode, weighted averaging processing may be performed on a parameter such as a Red, Green and Blue (RGB) value of a respective pixel in the third image and the first image according to the value (i.e., weight) of each pixel in the weight coefficient map, to obtain the second image. In an example, the RGB value of a pixel in the second image may be represented through the following formula (1):

\hat{x}=z·x_{w}+(1−z)·\tilde{x} (1)

\hat{x} is a RGB value of a pixel in the second image, z is a value (i.e., weight) of the corresponding pixel in the weight coefficient map, x_{w} is a RGB value of the corresponding pixel in the third image, and \tilde{x} is the RGB value of the corresponding pixel in the first image.

For example, if the value of the pixel of which the coordinate is (100, 100) in the weight coefficient map is 0.3, then the weight of the pixel of which the coordinate is (100, 100) in the third image is 0.3, the weight of the pixel of which the coordinate is (100, 100) in the first image is 0.7. Thus, the RGB value of the pixel of which the coordinate is (100, 100) in the third image is 200, the RGB value of the pixel of which the coordinate is (100, 100) in the first image is 50, and the RGB value of the pixel of which the coordinate is (100, 100) in the second image is 95.

In such a manner, a high-frequency detail in the image to be detected may be added to the first image in a weighted averaging manner to obtain the second image, so that the quality of the generated image is improved.

In a possible implementation mode, the image generation network may be trained before the first image is generated through the image generation network.

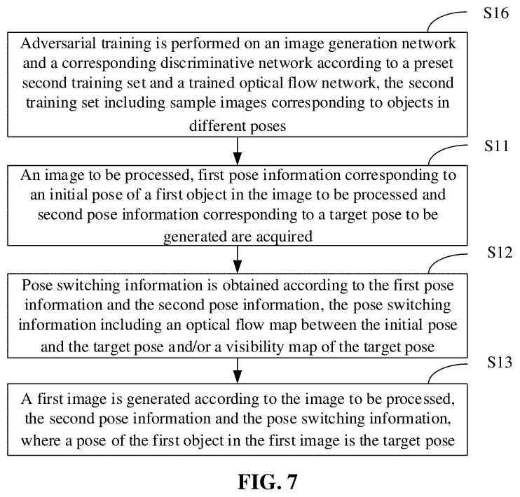

FIG. 7 is a flowchart of an image generation method according to an embodiment of the disclosure. As shown in FIG. 7, the method further includes the following step S16.

In S16, adversarial training is performed on the image generation network and a corresponding discriminative network according to a preset second training set and the trained optical flow network, the second training set including sample images corresponding to objects in different poses.

In a possible implementation mode, S16 may include the following operations. Pose feature extraction is performed on a third sample image and fourth sample image in the second training set to obtain fifth pose information of the object in the third sample image and sixth pose information of the object in the fourth sample image. The fifth pose information and the sixth pose information are input to the trained optical flow network to obtain a second optical flow map and a second visibility map. The third sample image, the second optical flow map, the second visibility map and the sixth pose information are input to the image generation network for processing to generate a sample generated image. Discrimination processing is performed on the sample-generated image or the fourth sample image through the discriminative network to obtain an authenticity discrimination result of the sample generated image. Adversarial training is performed on the discriminative network and the image generation network according to the fourth sample image, the sample generated image and the authenticity discrimination result.

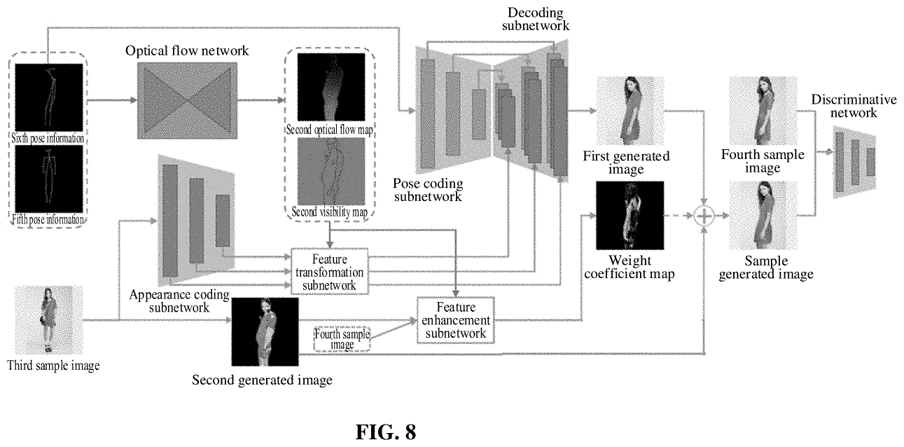

FIG. 8 is a schematic diagram of training of an image generation network according to an embodiment of the disclosure. The second training set may include the sample images corresponding to the objects in different poses. The third sample image and the fourth sample image are any sample images in the second training set. Pose feature extraction may be performed on the third sample image and the fourth sample image respectively. For example, 18 key points of an object are extracted respectively in the third sample image and the fourth sample image, to obtain the fifth pose information of the object in the third sample image and the sixth pose information of the object in the fourth sample image.

In a possible implementation mode, the fifth pose information and the sixth pose information may be processed through the trained optical flow network to obtain the second optical flow map and the second visibility map.

In a possible implementation mode, the second optical flow map and the second visibility map may also be obtained in a three-dimensional modeling manner A manner for obtaining the second optical flow map and the second visibility map is not limited in the disclosure.

In a possible implementation mode, the image generation network may be trained by use of the third sample image, the second optical flow map, the second visibility map and the sixth pose information. In an example, the image generation network may include the appearance feature coding subnetwork, the feature transformation subnetwork, the pose feature coding subnetwork and the decoding subnetwork. In another example, the image generation network may include the appearance feature coding subnetwork, the feature transformation subnetwork, the pose feature coding subnetwork, the decoding subnetwork and the feature enhancement subnetwork.

In a possible implementation mode, the third sample image may be input to the appearance feature coding subnetwork for processing, and an output result of the appearance feature coding subnetwork, the second optical flow map and the second visibility map are input to the feature transformation subnetwork to obtain a sample appearance feature map of the third sample image.

In a possible implementation mode, the sixth pose information may be input to the pose feature coding subnetwork for processing to obtain a sample pose feature map of the sixth pose information. Furthermore, the sample pose feature map and the sample appearance feature map may be input to the decoding subnetwork and processed to obtain a first generated image. Under the condition that the image generation network includes the appearance feature coding subnetwork, the feature transformation subnetwork, the pose feature coding subnetwork and the decoding subnetwork, adversarial training may be performed on the discriminative network and the image generation network by use of the first generated image and a fourth generated image.

In a possible implementation mode, under the condition that the image generation network includes the appearance feature coding subnetwork, the feature transformation subnetwork, the pose feature coding subnetwork, the decoding subnetwork and the feature enhancement subnetwork, pixel transformation processing may be performed on the third sample image according to the second optical flow map. That is, shifting processing is performed on pixels of the third sample image according to the optical flow information of the pixels in the optical flow map, to obtain a second generated image; the second generated image, the fourth sample image, the second optical flow map and the second visibility map are input to the feature enhancement subnetwork to obtain the weight coefficient map; and furthermore, weighted averaging processing may be performed on the second generated image and the first generated image according to the weight coefficient map to obtain the sample generated image. Adversarial training may be performed on the discriminative network and the image network subnetwork through the sample generated image and the fourth sample image.

In a possible implementation mode, the fourth sample image or the sample generated image may be input to the discriminative network to perform discrimination processing to obtain the authenticity discrimination result, namely determining whether the sample generated image is a real image or an unreal image (for example, artificially generated image). In an example, the authenticity discrimination result may be presented in the form of a probability. For example, a probability that the sample generated image is a real image is 80%.

In a possible implementation mode, network loss of the image generation network and the discriminative network may be obtained according to the fourth sample image, the sample generated image and the authenticity discrimination result, and then adversarial training is performed on the image generation network and the discriminative network according to the network loss. That is, network parameters of the image generation network and the discriminative network are adjusted according to the network loss, until the following two training conditions reach a balanced state: the network loss of the image generation network and the discriminative network is minimized, and the probability that the authenticity discrimination result output by the discriminative network indicates that the image is a real image is maximized In the balanced state, the discriminative network has a higher discrimination performance and can discriminate an artificially generated image (generated image with poor quality) and a real image. The image generated by the image generation network is higher, and the quality of the generated image is close to that of a real image, and as a result, the discriminative network is unlikely to discriminate whether the image is a generated image or a real image, namely in this case, a larger proportion of generated images are determined as real images by the discriminative network with higher discrimination performance In the balanced state, the quality of the image generated by the image generation network is higher and the image generation network has a higher performance. Therefore, the training is completed and the trained image generation network is then applied to the process of generating the second image.

In a possible implementation mode, the network loss of the image generation network and the discriminative network may be represented through the following formula (2):

L=λ₁L_{adv}+λ₂L₁+λ₃Lₚ (2)

λ₁, λ₂ and λ₃ are weights respectively, and the weight may be any preset value. A value of the weight is not limited in the disclosure. L_{adv} is network loss generated by adversarial training, L₁ is network loss generated by a difference between the fourth sample image and the sample generated image, and Lₚ is network loss of a multilevel feature map. L_{adv} may be represented through the following formula (3):

L_{adv}E[log D(x)]+E[log(1−D(G(x′)))] (3)

D (x) is the probability that the discriminative network determines the fourth sample image x as a real image, D(G(x′)) is the probability that the discriminative network determines the sample generated image x′ generated according to the image generation network, and E is an expected value.

L₁ may be represented through the following formula (4):

L₁=∥x′−x∥₁ (4)

∥x′−x∥₁ represents a 1-norm of a difference between a pixel of the fourth sample image x and a corresponding pixel of the sample generated image x′.

Lₚ may be represented through the following formula (5):

Lₚ=Σⱼ₌₁^{N}∥øⱼ(x′)−øⱼ(x)∥₂² (5)

The discriminative network may include multiple levels of convolutional layers, and the respective levels of convolutional layers may extract feature maps with different resolutions. The discriminative network may process the fourth sample image x and the sample generated image x′ respectively and determine network loss Lₚ of the multilevel feature map according to the feature maps extracted by the respective levels of convolutional layers, øⱼ(x′) being the feature map, extracted by the jth-level convolutional layer, of the sample generated image x′, øⱼ(x) being the feature map, extracted by the jth-level convolutional layer, of the fourth sample image x, and ∥øⱼ(x′)−øⱼ(x)∥₂² being a square of 2-norms of differences between a pixel in the øⱼ(x) and a corresponding pixel in the øⱼ(x′).

Adversarial training may be performed on the discriminative network and the image generation network according to the network loss determined through the formula (2), and when the two training conditions that the network loss of the image generation network and the discriminative network is minimized and the probability that the authenticity discrimination result output by the discriminative network indicates that the image is a real image is maximized reaches the balanced state, the training may be completed to obtain the trained image generation network, and the image generation network can be applied to generation of the first image or the second image.

According to the image generation method of the embodiment of the disclosure, the optical flow network is trained to generate an optical flow map and a visibility map according to any pose information, which provides basis for generating the first image of the first object in any pose. The optical flow network trained through the three-dimensional models has a higher accuracy. The visibility map and the optical flow map are obtained according to the first pose information and the second pose information, so that the visibility of each part of the first object may be obtained. Shifting processing is performed on the first feature map according to the optical flow map, and the visible part and invisible part may be determined according to the visibility map, so that the image distortions are improved and the artifacts are reduced. Furthermore, the pose feature map obtained by performing pose coding processing on the second pose information and the appearance feature map where the visible part is distinguished from the invisible part may be decoded to obtain the first image corresponding to the first object in the target pose, so that the image distortions can be improved, and the artifacts can be reduced. The high-frequency detail in the image to be detected may be added to the first image in the weighted averaging manner to obtain the second image, so that the quality of the generated image is improved.

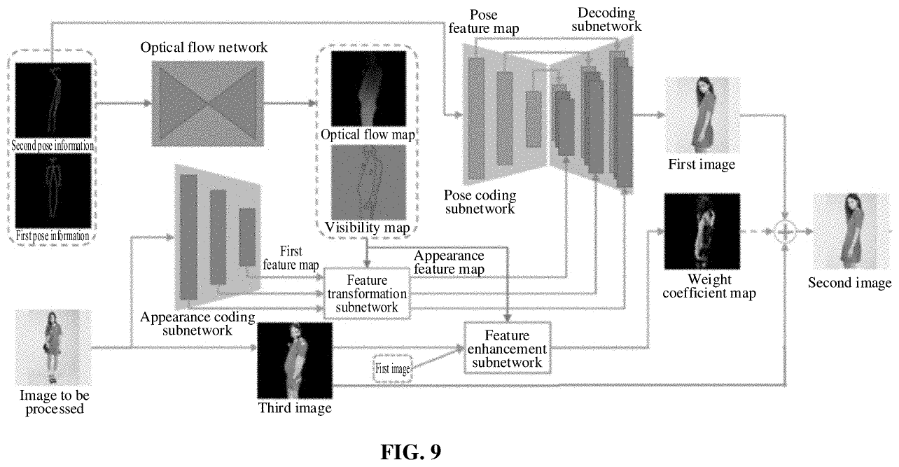

FIG. 9 is a schematic diagram of application of an image generation method according to an embodiment of the disclosure. As shown in FIG. 9, an image to be processed includes a first object in an initial pose. Pose feature extraction may be performed on the image to be processed, for example, 18 key points of the first object may be extracted, to obtain first pose information. Second pose information is pose information corresponding to any target pose to be generated.

In a possible implementation mode, the first pose information and the second pose information may be input to an optical flow network to obtain an optical flow map and a visibility map.

In a possible implementation mode, the image to be processed is input to an appearance feature coding subnetwork of the image generation network, and appearance feature coding processing is performed on the image to be processed to obtain a first feature map. Furthermore, a feature transformation subnetwork of the image generation network may perform feature transformation processing on the first feature map according to the optical flow map and the visibility map to obtain an appearance feature map.

In a possible implementation mode, the second pose information may be input to a pose feature coding subnetwork of the image generation network, and pose coding processing is performed on the second pose information to obtain a pose feature map of the first object.

In a possible implementation mode, decoding processing may be performed on the pose feature map and the appearance feature map through a decoding subnetwork of the image generation network to obtain a first image. In the first image, a pose of the first object is the target pose corresponding to the second pose information.

In a possible implementation mode, pixel transformation processing may be performed on the image to be processed through the optical flow map, namely shifting processing is performed on each pixel of the image to be processed according to corresponding optical flow information, to obtain a third image. Furthermore, the third image, the first image, the optical flow map and the visibility map may be input to a feature enhancement subnetwork of the image generation network and processed to obtain a weight coefficient map. Weighted averaging processing is performed on the first image and the third image according to the weight coefficient map to obtain a second image with high-frequency details (for example, a winkle and a texture).

In a possible implementation mode, the image generation method may be applied to generation of a video or a dynamic graph, for example, generation of multiple images corresponding to continuous motions of a certain object to constitute a video or a dynamic graph. Or, the image generation method may be applied to a scenario such as virtual fitting, and images of a fitting object at multiple viewing angles or in multiple poses may be generated.

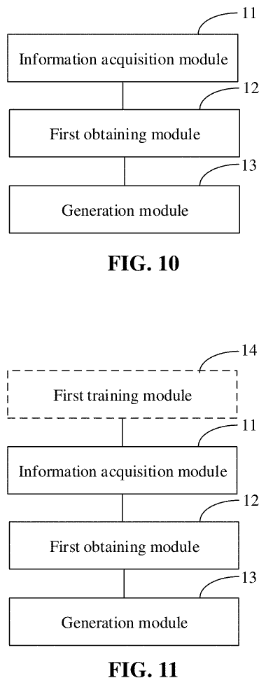

FIG. 10 is a block diagram of an image generation device according to an embodiment of the disclosure. As shown in FIG. 10, the device includes an information acquisition module 11, a first obtaining module 12 and a generation module 13.

The information acquisition module 11 is configured to acquire an image to be processed, first pose information corresponding to an initial pose of a first object in the image to be processed and second pose information corresponding to a target pose to be generated.

The first obtaining module 12 is configured to obtain pose switching information according to the first pose information and the second pose information, where the pose switching information includes an optical flow map between the initial pose and the target pose and/or a visibility map of the target pose.

The generation module 13 is configured to generate a first image according to the image to be processed, the second pose information and the pose switching information, where a pose of the first object in the first image is the target pose.

In a possible implementation mode, the generation module is further configured to:

obtain an appearance feature map of the first object according to the image to be processed and the pose switching information; and

generate the first image according to the appearance feature map and the second pose information.

In a possible implementation mode, the generation module is further configured to:

perform appearance feature coding processing on the image to be processed to obtain a first feature map of the image to be processed; and

perform feature transformation processing on the first feature map according to the pose switching information to obtain the appearance feature map.

In a possible implementation mode, the generation module is further configured to:

perform pose coding processing on the second pose information to obtain a pose feature map of the first object; and

perform decoding processing on the pose feature map and the appearance feature map to generate the first image.

In a possible implementation mode, the information acquisition module is further configured to:

perform pose feature extraction on the image to be processed to obtain the first pose information corresponding to the initial pose of the first object in the image to be processed.

In a possible implementation mode, the device includes a neural network, and the neural network includes an optical flow network configured to obtain the pose switching information.

FIG. 11 is a block diagram of an image generation device according to an embodiment of the disclosure. As shown in FIG. 11, the device further includes a first training module 14.

The first training module 14 is configured to train the optical flow network according to a preset first training set, the first training set including sample images corresponding to objects in different poses.

In a possible implementation mode, the first training module is further configured to:

perform three-dimensional modeling on a first sample image and second sample image in the first training set to obtain a first three-dimensional model and a second three-dimensional model respectively;

obtain a first optical flow map between the first sample image and the second sample image and a first visibility map of the second sample image according to the first three-dimensional model and the second three-dimensional model;

perform pose feature extraction on the first sample image and the second sample image to obtain third pose information of the object in the first sample image and fourth pose information of the object in the second sample image respectively;

input the third pose information and the fourth pose information to the optical flow network to obtain a predicted optical flow map and a predicted visibility map;

determine network loss of the optical flow network according to the first optical flow map, the predicted optical flow map, the first visibility map and the predicted visibility map; and

train the optical flow network according to the network loss of the optical flow network.

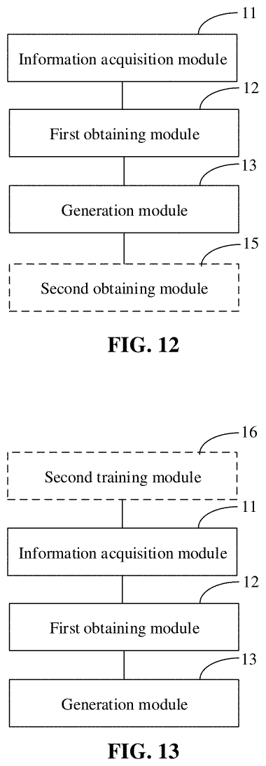

FIG. 12 is a block diagram of an image generation device according to an embodiment of the disclosure. As shown in FIG. 12, the device further includes a second obtaining module 15.

The second obtaining module 15 is configured to perform feature enhancement processing on the first image according to the pose switching information and the image to be processed to obtain a second image.

In a possible implementation mode, the second obtaining module is further configured to:

perform pixel transformation processing on the image to be processed according to the optical flow map to obtain a third image;

obtain a weight coefficient map according to the third image, the first image and the pose switching information; and

perform weighted averaging processing on the third image and the first image according to the weight coefficient map to obtain the second image.

In a possible implementation mode, the neural network also includes an image generation network, and the image generation network is configured for image generation.

FIG. 13 is a block diagram of an image generation device according to an embodiment of the disclosure. As shown in FIG. 13, the device further includes a second training module 16.

The second training module 16 is configured to perform adversarial training on the image generation network and a corresponding discriminative network according to a preset second training set and the trained optical flow network, where the second training set includes sample images corresponding to objects in different poses.

In a possible implementation mode, the second training module is further configured to:

perform pose feature extraction on a third sample image and fourth sample image in the second training set to obtain fifth pose information of the object in the third sample image and sixth pose information of the object in the fourth sample image;

input the fifth pose information and the sixth pose information to the trained optical flow network to obtain a second optical flow map and a second visibility map;

input the third sample image, the second optical flow map, the second visibility map and the sixth pose information to the image generation network and process them to generate a sample generated image;

perform discrimination processing on the sample-generated image or the fourth sample image through the discriminative network to obtain an authenticity discrimination result of the sample generated image; and

perform adversarial training on the discriminative network and the image generation network according to the fourth sample image, the sample generated image and the authenticity discrimination result.

It can be understood that each method embodiment mentioned in the disclosure may be combined to form combined embodiments without departing from principles and logics, and in order to save space, it will not be elaborated in the disclosure.

In addition, the disclosure also provides an image generation device, an electronic device, a computer-readable storage medium and a program. All of them may be configured to implement any method provided in the disclosure. Corresponding technical solutions and descriptions refer to the corresponding records in the method part and will not be elaborated herein.

It can be understood by those skilled in the art that, in the method of the specific implementation modes, the writing sequence of each step does not mean a strict execution sequence and is not intended to form any limit to the implementation process and a specific execution sequence of each step should be determined by functions and probable internal logic thereof.

In some embodiments, functions or modules of the device provided in the embodiments of the disclosure may be configured to execute the method described in the above method embodiments and specific implementation thereof may refer to the descriptions about the method embodiments and will not be elaborated herein for simplicity.

An embodiment of the disclosure also discloses a computer-readable storage medium, having stored therein computer program instructions, where the computer program instructions, when being executed by a processor, cause the processor to implement the abovementioned method. The computer-readable storage medium may be a nonvolatile computer-readable storage medium or a volatile computer-readable storage medium.

An embodiment of the disclosure also discloses an electronic device, which includes a processor and a memory configured to store instructions executable by the processor, where the processor is configured to implement the abovementioned method.

An embodiment of the disclosure also discloses a computer program, which includes computer-readable codes, where the computer-readable code, when running in an electronic device, enable a processor in the electronic device to execute the abovementioned method.

The electronic device may be provided as a terminal, a server or a device in another form.

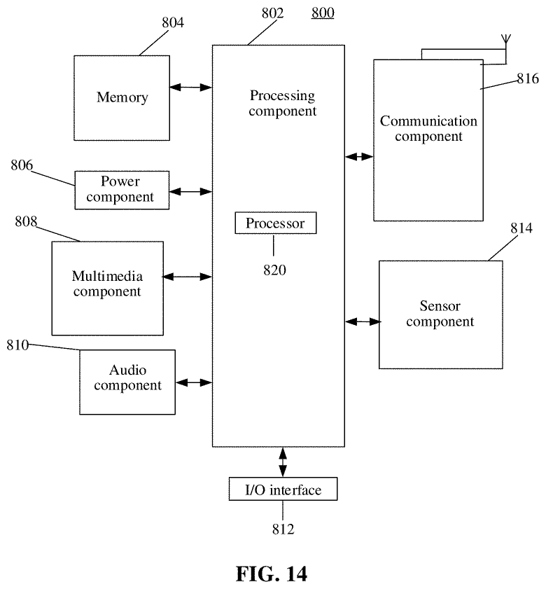

FIG. 14 is a block diagram of an electronic device 800 according to an exemplary embodiment. For example, the electronic device 800 may be a terminal such as a mobile phone, a computer, a digital broadcast terminal, a messaging device, a gaming console, a tablet, a medical device, exercise equipment and a personal digital assistant.

Referring to FIG. 14, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or nonvolatile storage device of any type or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. The touch sensors may not only sense a boundary of a touch or swipe action but also detect a duration and pressure associated with the touch or swipe action. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology and another technology.

In the exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In the exemplary embodiment, a nonvolatile computer-readable storage medium is also provided, for example, a memory 804 including computer program instructions. The computer program instructions may be executed by a processor 820 of an electronic device 800 to implement the abovementioned method.

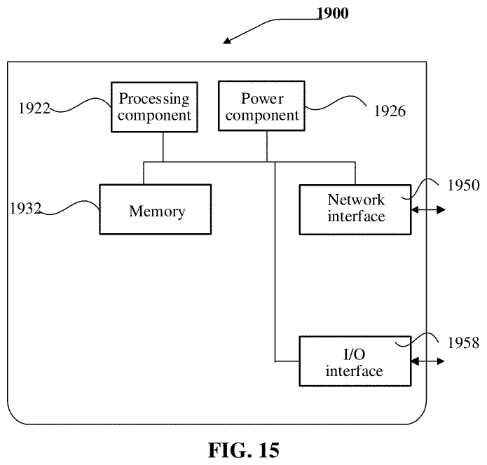

FIG. 15 is a block diagram of an electronic device 1900 according to an exemplary embodiment. For example, the electronic device 1900 may be provided as a server. Referring to FIG. 15, the electronic device 1900 includes a processing component 1922, further including one or more processors, and a memory resource represented by a memory 1932, configured to store instructions executable by the processing component 1922, for example, an application program. The application program stored in the memory 1932 may include one or more than one module of which each corresponds to a set of instructions. In addition, the processing component 1922 is configured to execute the instructions to execute the abovementioned method.

The electronic device 1900 may further include a power component 1926 configured to execute power management of the electronic device 1900, a wired or wireless network interface 1950 configured to connect the electronic device 1900 to a network and an I/O interface 1958. The electronic device 1900 may be operated based on an operating system stored in the memory 1932, for example, Windows Server™, Mac OS X™, Unix™, Linux™, FreeBSD™ or the like.

In the exemplary embodiment, a nonvolatile computer-readable storage medium is also provided, for example, a memory 1932 including computer program instructions. The computer program instructions may be executed by a processing component 1922 of an electronic device 1900 to implement the abovementioned method.

The disclosure may be a system, a method and/or a computer program product. The computer program product may include computer-readable storage mediums having stored thereon computer-readable program instructions configured to enable a processor to implement each aspect of the disclosure.

The computer-readable storage medium may be a physical device capable of retaining and storing an instruction used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a RAM, a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described herein may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instructions configured to execute the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely executed in a computer of a user or partially executed in the computer of the user, executed as an independent software package, executed partially in the computer of the user and partially in a remote computer, or executed completely in the remote server or a server. Under the condition that the remote computer is involved, the remote computer may be connected to the computer of the user through any type of network including an LAN or a WAN, or, may be connected to an external computer (for example, connected by an Internet service provider through the Internet). In some embodiments, an electronic circuit such as a programmable logic circuit, an FPGA or a Programmable Logic Array (PLA) may be customized by use of state information of a computer-readable program instruction, and the electronic circuit may execute the computer-readable program instruction, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Different embodiments of the disclosure may be combined without departing from logics, different embodiments are described with different emphases, and emphasized parts may refer to records in the other embodiments.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or improvements in the technologies in the market best or enable others of ordinary skill in the art to understand each embodiment disclosed herein.

1. An image generation method, comprising:
acquiring an image to be processed, first pose information corresponding to an initial pose of a first object in the image to be processed and second pose information corresponding to a target pose to be generated;
obtaining pose switching information according to the first pose information and the second pose information, wherein the pose switching information comprises at least one of:
an optical flow map between the initial pose and the target pose, or a visibility map of the target pose; and
generating a first image according to the image to be processed, the second pose information and the pose switching information, where a pose of the first object in the first image is the target pose.

2. The method of claim 1, wherein generating the first image according to the image to be processed, the second pose information and the pose switching information comprises:
obtaining an appearance feature map of the first object according to the image to be processed and the pose switching information; and
generating the first image according to the appearance feature map and the second pose information.

3. The method of claim 2, wherein obtaining the appearance feature map of the first object according to the image to be processed and the pose switching information comprises:
performing appearance feature coding processing on the image to be processed to obtain a first feature map of the image to be processed; and
performing feature transformation processing on the first feature map according to the pose switching information to obtain the appearance feature map.

4. The method of claim 2, wherein generating the first image according to the appearance feature map and the second pose information comprises:
performing pose coding processing on the second pose information to obtain a pose feature map of the first object; and
performing decoding processing on the pose feature map and the appearance feature map to generate the first image.

5. The method of claim 1, further comprising:
performing feature enhancement processing on the first image according to the pose switching information and the image to be processed, to obtain a second image.

6. The method of claim 5, wherein performing feature enhancement processing on the first image according to the pose switching information and the image to be processed, to obtain the second image comprises:
performing pixel transformation processing on the image to be processed according to the optical flow map to obtain a third image;
obtaining a weight coefficient map according to the third image, the first image and the pose switching information; and
performing weighted averaging processing on the third image and the first image according to the weight coefficient map to obtain the second image.

7. The method of claim 1, wherein acquiring the first pose information corresponding to the initial pose of the first object in the image to be processed comprises:
performing pose feature extraction on the image to be processed to obtain the first pose information corresponding to the initial pose of the first object in the image to be processed.

8. The method of claim 1, wherein the method is implemented through a neural network, and wherein the neural network comprises an optical flow network configured to obtain the pose switching information.

9. The method of claim 8, further comprising:
training the optical flow network according to a preset first training set, the preset first training set comprising sample images corresponding to objects in different poses.

10. The method of claim 9, wherein training the optical flow network according to the preset first training set comprises:
performing three-dimensional modeling on a first sample image and second sample image in the preset first training set to obtain a first three-dimensional model and a second three-dimensional model respectively;
obtaining a first optical flow map between the first sample image and the second sample image and a first visibility map of the second sample image according to the first three-dimensional model and the second three-dimensional model;
performing pose feature extraction on the first sample image and the second sample image to obtain third pose information of an object in the first sample image and fourth pose information of an object in the second sample image respectively;
inputting the third pose information and the fourth pose information to the optical flow network to obtain a predicted optical flow map and a predicted visibility map;
determining network loss of the optical flow network according to the first optical flow map, the predicted optical flow map, the first visibility map and the predicted visibility map; and
training the optical flow network according to the network loss of the optical flow network.

11. The method of claim 8, wherein the neural network further comprises an image generation network configured for image generation.

12. The method of claim 11, further comprising:
performing adversarial training on the image generation network and a discriminative network according to a preset second training set and a trained optical flow network, the preset second training set comprising sample images corresponding to objects in different poses.

13. The method of claim 12, wherein performing adversarial training on the image generation network and the discriminative network according to the preset second training set and the trained optical flow network comprises:
performing pose feature extraction on a third sample image and fourth sample image in the preset second training set to obtain fifth pose information of an object in the third sample image and sixth pose information of an object in the fourth sample image;
inputting the fifth pose information and the sixth pose information to the trained optical flow network to obtain a second optical flow map and a second visibility map;
inputting the third sample image, the second optical flow map, the second visibility map and the sixth pose information to the image generation network for processing to generate a sample generated image;
performing discrimination processing on the sample generated image or the fourth sample image through the discriminative network to obtain an authenticity discrimination result of the sample generated image; and
performing adversarial training on the discriminative network and the image generation network according to the fourth sample image, the sample generated image and the authenticity discrimination result.

14. An image generation device, comprising: a processor; and a memory configured to store instructions executable by the processor, wherein the processor is configured to:
acquire an image to be processed, first pose information corresponding to an initial pose of a first object in the image to be processed and second pose information corresponding to a target pose to be generated;
obtain pose switching information according to the first pose information and the second pose information, wherein the pose switching information comprises at least one of:
an optical flow map between the initial pose and the target pose, or a visibility map of the target pose; and
generate a first image according to the image to be processed, the second pose information and the pose switching information, a pose of the first object in the first image being the target pose.

15. The device of claim 14, wherein the processor is further configured to:
obtain an appearance feature map of the first object according to the image to be processed and the pose switching information; and
generate the first image according to the appearance feature map and the second pose information.

16. The device of claim 15, wherein the processor is further configured to:
perform appearance feature coding processing on the image to be processed to obtain a first feature map of the image to be processed; and
perform feature transformation processing on the first feature map according to the pose switching information to obtain the appearance feature map.

17. The device of claim 15, wherein the processor is further configured to:
perform pose coding processing on the second pose information to obtain a pose feature map of the first object; and
perform decoding processing on the pose feature map and the appearance feature map to generate the first image.

18. The device of claim 14, wherein the processor is further configured to:
perform feature enhancement processing on the first image according to the pose switching information and the image to be processed, to obtain a second image.

19. The device of claim 18, wherein the processor is further configured to:
perform pixel transformation processing on the image to be processed according to the optical flow map to obtain a third image;
obtain a weight coefficient map according to the third image, the first image and the pose switching information; and
perform weighted averaging processing on the third image and the first image according to the weight coefficient map to obtain the second image.

20. A non-transitory computer-readable storage medium, having stored thereon computer program instructions, wherein the computer program instructions, when being executed by a processor, enable the processer to implement an image generation method, the method comprising:
acquiring an image to be processed, first pose information corresponding to an initial pose of a first object in the image to be processed and second pose information corresponding to a target pose to be generated;
obtaining pose switching information according to the first pose information and the second pose information, wherein the pose switching information comprises at least one of:
an optical flow map between the initial pose and the target pose, or a visibility map of the target pose; and
generating a first image according to the image to be processed, the second pose information and the pose switching information, where a pose of the first object in the first image is the target pose.
